(19) United States
(12) Patent Application Publication
(10) Pub. No.: US 2015/0003884 A1
(43) Pub. Date: Jan. 1, 2015

(54) Liquid Applicator Device

(71) Applicant: IVM PTY LTD, Nerang (AU)

(72) Inventor: George Kast, Wongawallan (AU)

(21) Appl. No.: 14/370,920

(22) PCT Filed: Jan. 7, 2013
(86) PCT No.: PCT/AU2013/000007

§ 371 Date: Jul. 7, 2014

(30) Foreign Application Priority Data
Jan. 7, 2012 (AU) 2012900061

(51) Int. Cl. B05C 17/005; A01M 21/04

(52) U.S. Cl. CPC B05C 17/00569; B05C 17/00583; B05C 17/0052; A01M 21/043
USPC 401/4; 401/150; 401/6

(57) ABSTRACT

A liquid applicator (10, 10A, 10B, 10C, 10D, 10E, 10F) having (i) a container in the form of a collapsible bladder (11, 11A, 11B, 11C) for containing a supply of liquid in use; (ii) a positive displacement pump (12, 12A) in flow communication with the container (11, 11A, 11B, 11C) which has a variable capacity chamber for delivering a metered or measured quantity of liquid; and (Hi) a contact device (20, 46A, 46A, 60) in flow communication with the positive displacement pump (12, 12A) wherein the metered or measured dosage of liquid is delivered to a plant or other substrate.

### FIELD OF THE INVENTION

This invention relates to an applicator device which may be utilised for selective delivery of fluids inclusive of liquids and gels to a desired substrate such as plants and other forms of vegetation and other substrates.

### BACKGROUND TO THE INVENTION

Applicator devices are well known and reference may be made for example to U.S. Pat. No. 4,072,128 which comprises a body member of a liquid reservoir therein, a manually operable pump in communication with the reservoir and an applicator post mounted on the pump which may be connected to a hose. A metered amount of liquid is supplied to an inner surface of a portion of a tubular member by manually placing the tubular member portion over the applicator post and then pressing inwardly over the device.

Reference also may be made to U.S. Pat. No. 5,690,738 which described a liquid dispenser and contact applicator having at least one roller for contacting advancing work pieces and applying liquid to surfaces thereof as they pass. Use is made of a cyclically repeatable volumetric displacement pump which meters predetermined quantities of the liquid from a source to a dispensing tube extending axially along the applicator member.

However it will be appreciated in regard to both U.S. Pat. Nos. 4,072,128 and 5,690,738 that these applicator devices would not be suitable for applying herbicides to plants as the substrate which is to be contacted by these applicator devices includes work pieces in the case of U.S. Pat. No. 5,690,738 and an internal surface of a tube in the case of U.S. Pat. No. 4,072,128. It will also be appreciated that the structure of these applicator devices are relatively complicated.

Reference may also be made to U.S. Pat. No. 6,092,952 which describes an applicator bottle having a hand grip neck, a trigger mounted for index finger operation of a pump whereby the pump delivers liquid by the bottle. An important feature of this invention however is the provision of an upwardly canted backing plate having a sponge wherein the angle of canting is about 20 to 30 degrees. Again the structure of this applicator is unnecessarily complicated having regard to the use of a upwardly canted backing plate.

Reference also may be made to U.S. Pat. No. 6,145,703 which is a multi-dose spray applicator for dispensing a pharmaceutical liquid from a sealed container wherein use is made of a manually operable metering pump for delivery the pharmaceutical as a nasal spray. Reference is also made to a hollow needle associated with the pump for penetrating a membrane sealing the container and dispensing the pharmaceutical liquid through the pump. Again this applicator would not be suitable for application to plants and is unnecessarily complicated and dangerous to users having regard to the feature of the hollow needle.

Finally reference may be made to AU Patent 673075 which describes a liquid applicator head which can be fastened to a bottle, tube or other reservoir. The liquid applicator head has a body, a brush extending from the body and a valve assembly within the body to enable supply of liquid. The brush is associated with the valve assembly so that movement of the brush causes actuation of the valve assembly and consequent supply of liquid. The brush can be a bristle brush or an open cell foam brush. The applicator head can be used for applying herbicides or other liquids to plants. Again it is considered that the structure of this applicator head is unnecessarily complicated in that it requires a valve assembly which is dependant upon movement of the brush and consequent supply of liquid to the plants. This applicator was also disadvantageous in that the required dose could not be properly calibrated.

### OBJECT OF THE INVENTION

It is therefore an object of the invention to provide an applicator device which is simple in structure and which may alleviate disadvantages of the prior art described above. The applicator device of the invention is also particularly suited for application to substrates inclusive of plants.

This invention provides a liquid applicator which has:
(i) a container in the form of a collapsible bladder for containing a supply of liquid in use;
(ii) one or more positive displacement pumps in flow communication with the container which has a variable capacity chamber for delivering a metered or measured dosage of liquid; and
(iii) a contact device in flow communication with the positive displacement pump wherein said metered or measured dosage of liquid is delivered to a plant or other substrate.

Preferably there is provided a support housing or tube which has at one end thereof an internal compartment located adjacent to the contact device and in flow communication with the support tube which has a volumetric capacity greater than the metered dose of liquid whereby said metered dose is delivered to said internal compartment and retained therein prior to being delivered to the contact device.

There also may be provided a fluid coupling attached to a fluid inlet of the collapsible bladder which interconnects the fluid inlet to a conduit in flow communication with the pump.

The fluid inlet may be provided with an access assembly to which the fluid coupling may be releasably attached most preferably by screw threaded engagement. Most preferably the fluid coupling includes a male component and a female component or more preferably a plug component and a socket component. In this embodiment each of the plug component and the socket component may each be provided with a valve assembly which when connected to each other provide for liquid to enter the bladder from the conduit. There also may be provided a releasable engagement means between the plug component and the socket component such as corresponding bayonet fittings, screw threaded engagement or by snap fit or interference fit. Alternatively a clip may be used. In another arrangement a push button or other suitable movable actuator may be utilised which is biased by a spring to a closed position but when the push button is moved releases a latch which normally retains the plug component within the socket component in an assembled position but when moved enables separation of the plug component from the socket component.

Each of the valve assemblies of the plug component and the socket component may have a movable valve member which each may include a spring operated plunger wherein each plunger is biased towards an assembled position of plug component and socket component. When the plug component is inserted into the socket component, one plunger may abut the other plunger to allow fluid to pass through each of the plug component and the socket component.

The bladder is preferably contained in a hollow box or housing together with the fluid coupling with the fluid coupling extending outwardly therefrom so as to be connectable to the conduit. Preferably the conduit may be connected to the fluid coupling by a hollow member having a plurality of hose barbs. The hollow box or housing may be provided a retaining plate having a slot to retain the fluid coupling in the desired outwardly extended orientation. There may also be provided a pouch made of flexible material attached to a belt which houses the box and facilitates connection of the fluid coupling to the conduit in use.

The positive displacement pump used in the invention may be of any suitable type and thus may comprise a reciprocating pump such as direct action piston or diaphragm which can be used to deliver a controlled or metered amount of fluid. A peristaltic pump or bellows-type pump may also be used. The pump is preferably self-priming so that the liquid need not be supplied to it under pressure. The pump is most suitably a cyclically operable volumetric metering device. A particular pump that may be used in the aspect of the invention is shown in U.S. Pat. No. 7,690,738. The pump for use in the invention is suitably manually operable such as by the use of a trigger connected to the pump or by the use of a manually operable rod which may be actuated against the bias of a spring.

The support housing or tube for use in the invention may enclose the positive displacement pump in one arrangement and thus be operated by a trigger device located externally of the support housing or tube. In an alternative arrangement the positive displacement pump may be separate from the support housing or tube and thus be operated by the trigger device which is located externally of the pump. In either arrangement the trigger device may bear against or is in abutment with a reciprocating member of the pump such as a piston or diaphragm.

The metered amount of liquid may be delivered to the internal compartment preferably through a flexible or rigid conduit located within the support housing or tube.

The contact device for use in the invention may be a brush, roller, wiping sleeve or sheet and is preferably attached to an adjacent end of the support housing or tube by a holder which may be surrounded by the internal compartment. There also may be provided an internal partition between the support housing or tube and the internal compartment which may contain a flow aperture for passage of fluid travelling in the supply hose or rigid tube to the internal compartment. The holder may also be attached to the internal partition.

In another embodiment of the invention the internal compartment may be dispensed with and a contact device is located at one end of the support housing or tube which may be a pad so that metered amount(s) of fluid may be passed to the pad.

In another embodiment the container is in flow communication with the pump which may be manually operable by the trigger described above. The cable may be surrounded by the flexible conduit discussed above. The pump may be in fluid communication with the support housing or tube so that liquid may be caused to flow to the contact device which in this embodiment may comprise a pair of opposed jaws preferably having pads attached thereto which may be moved inwardly and outwardly in a reciprocating movement by movement of the actuating cable or rod wherein the substrate which is located between the jaws may be contacted by the liquid. Alternatively and less preferably only one jaw or other contact device may be used.

### PREFERRED EMBODIMENT

Reference may be made to preferred embodiments applicator of the invention as shown in the attached drawings wherein:

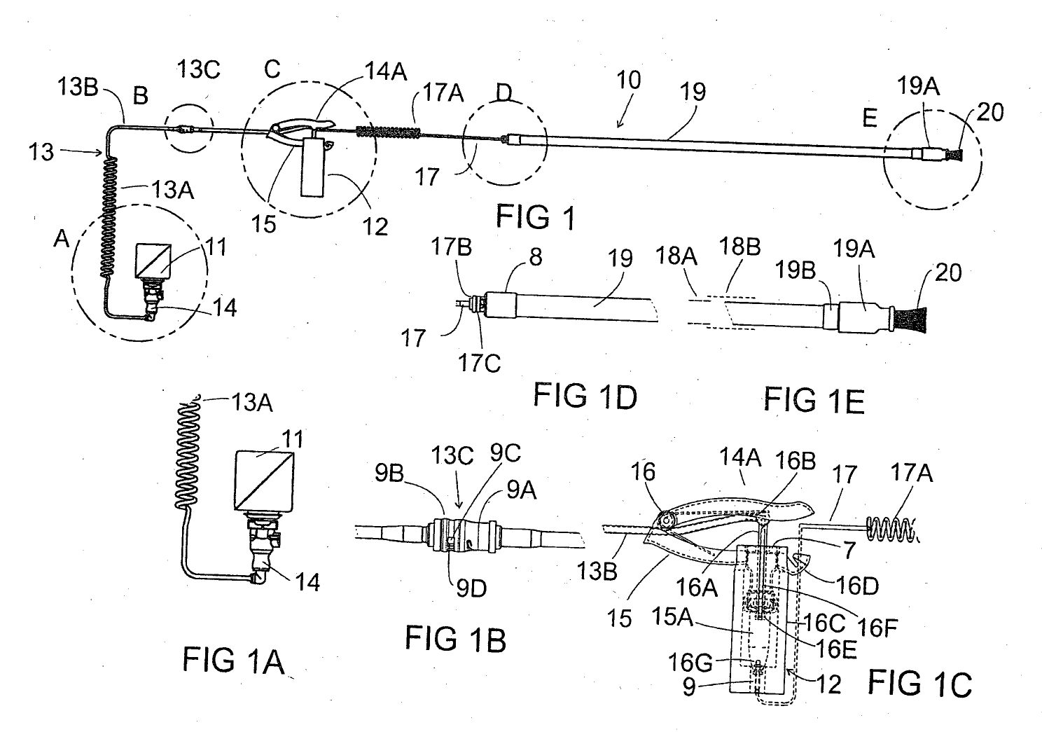

FIG. 1 is a side view of a first embodiment of the applicator;

FIG. 1A is an enlarged view of detail “A” shown in FIG. 1;

FIG. 1B is an enlarged view of detail “B” shown in FIG. 1;

FIG. 1C is an enlarged view of detail “C” shown in FIG. 1;

FIG. 1D is an enlarged view of detail “D” shown in FIG. 1;

FIG. 1E is an enlarged view of detail “E” shown in FIG. 1;

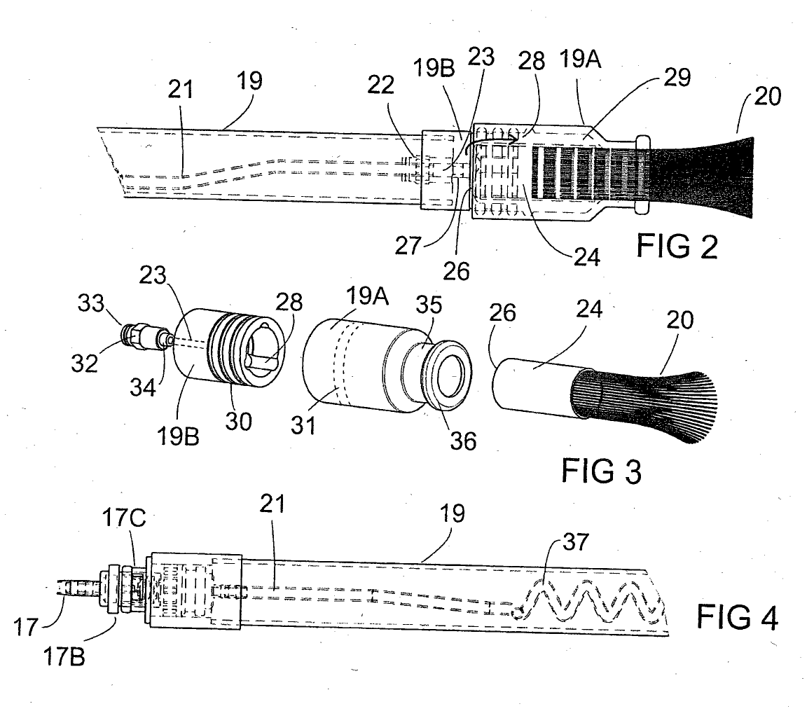

FIG. 2 is a detailed side view of detail “E” shown in FIG. 1;

FIG. 3 is an exploded perspective of the applicator of FIG. 2;

FIG. 4 is a detailed side view of detail “D” shown in FIG. 1;

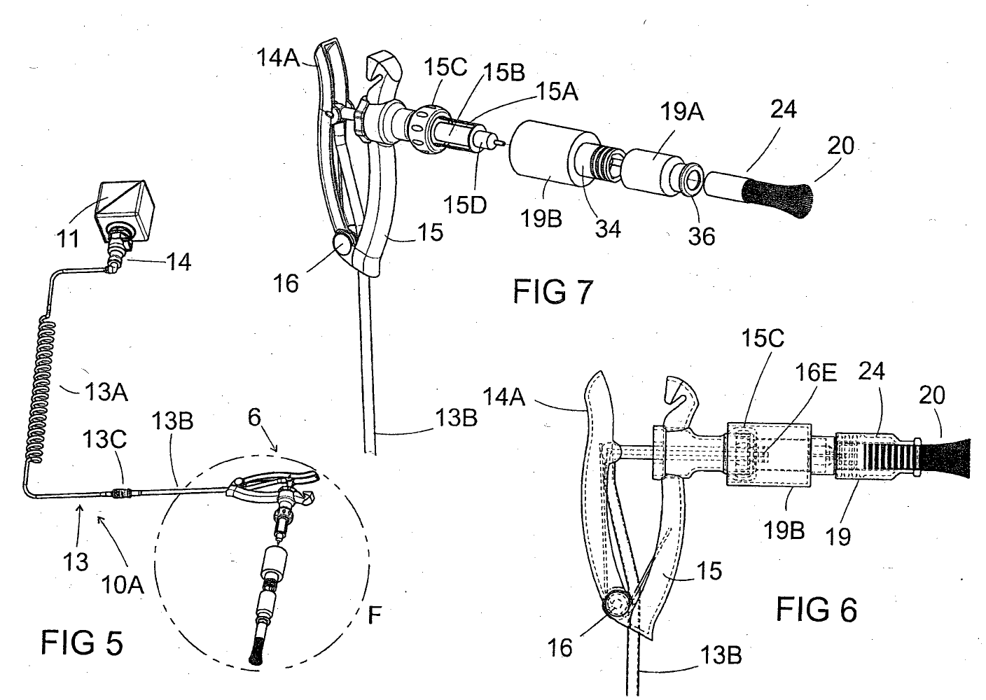

FIG. 5 is a perspective side view of a second embodiment of the applicator of the invention;

FIG. 6 is an enlarged exploded perspective view of detail “F” shown in FIG. 5;

FIG. 7 is a perspective side view of detail “F” shown in FIG. 6;

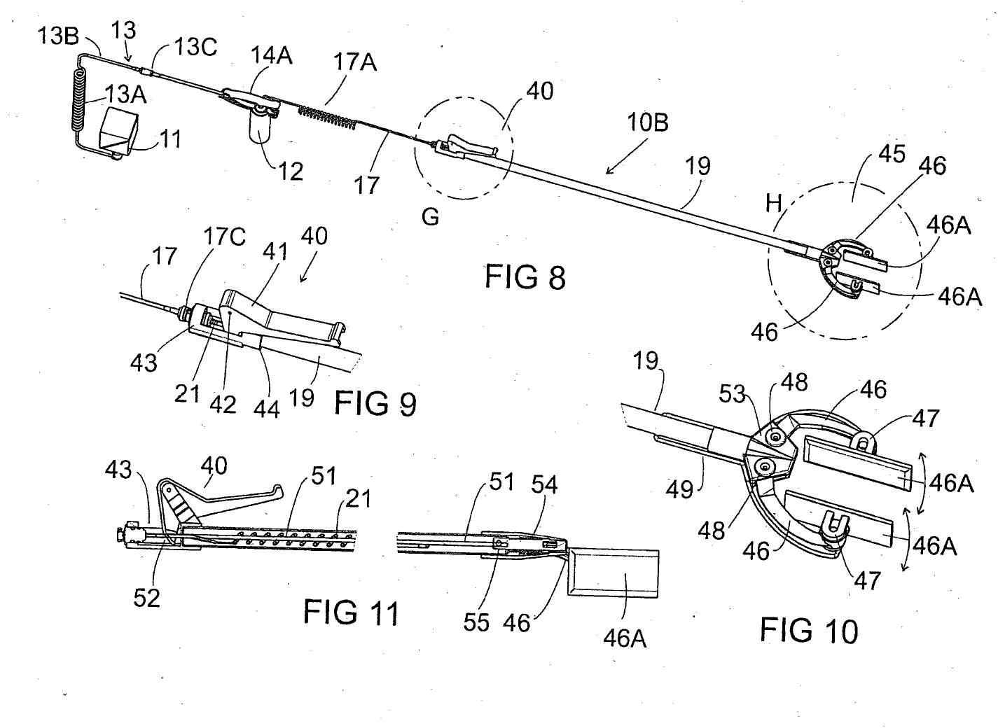

FIG. 8 is a perspective view of a third embodiment of the applicator of the invention;

FIG. 9 is an enlarged perspective view of detail “G” shown in FIG. 8;

FIG. 10 is an enlarged perspective view of detail “H” shown in FIG. 8;

FIG. 11 is an internal view or sectional view of the embodiment shown in FIG. 8;

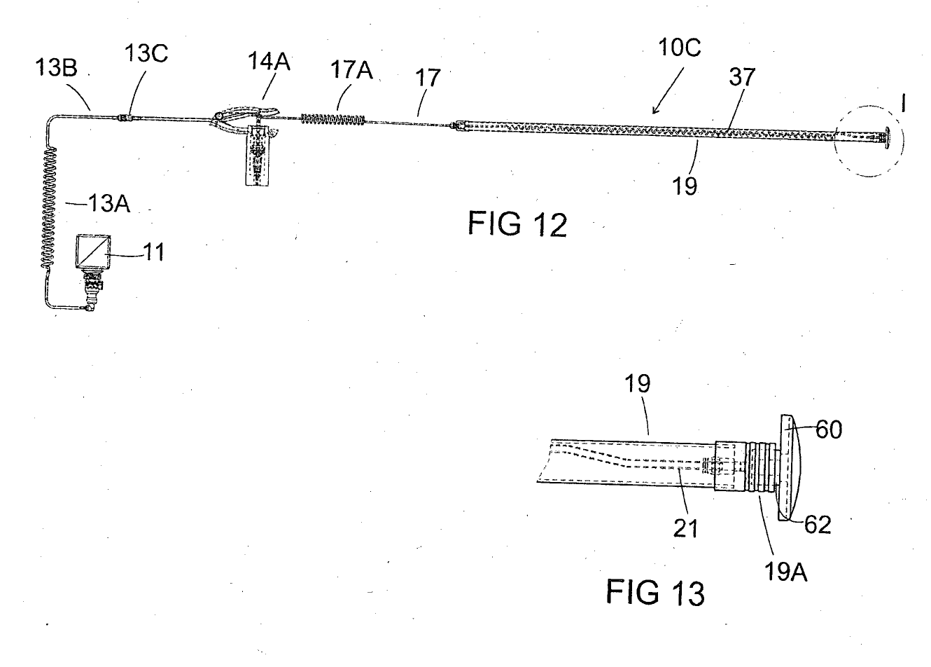

FIG. 12 is a side view of a fourth embodiment of the applicator of the invention;

FIG. 13 is an enlarged view of detail “I” shown in FIG. 12;

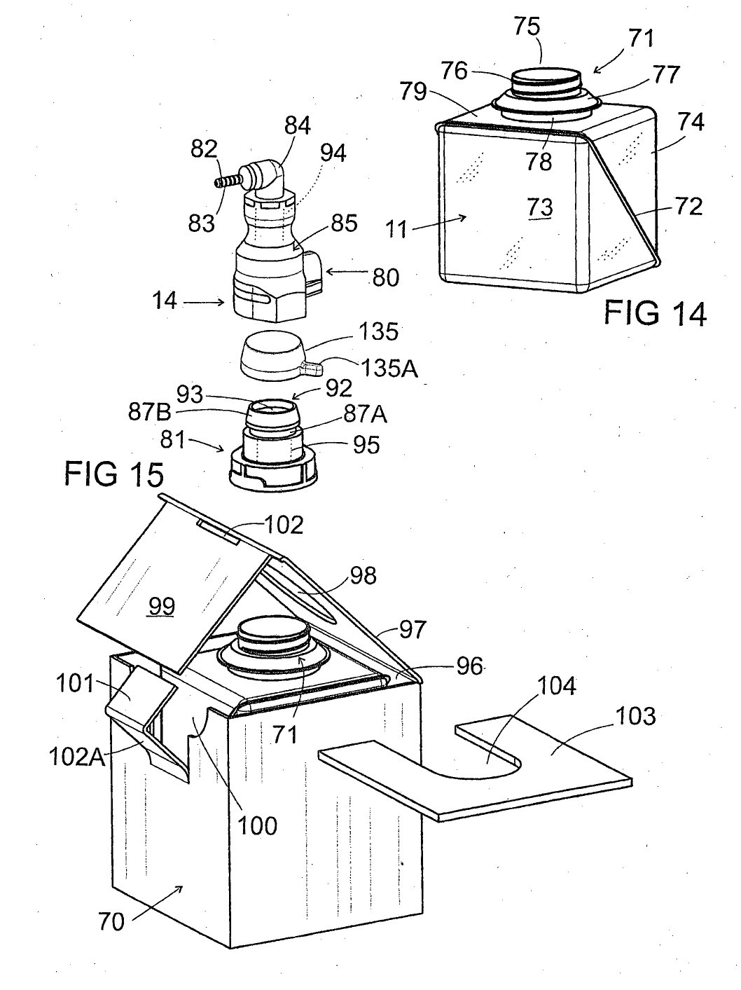

FIG. 14 is a perspective view of the container when in the form of a collapsible bladder;

FIG. 15 is an exploded perspective view of part of the bladder of FIG. 14 contained in a rigid housing and also a plug component and socket Component of the hydraulic coupling;

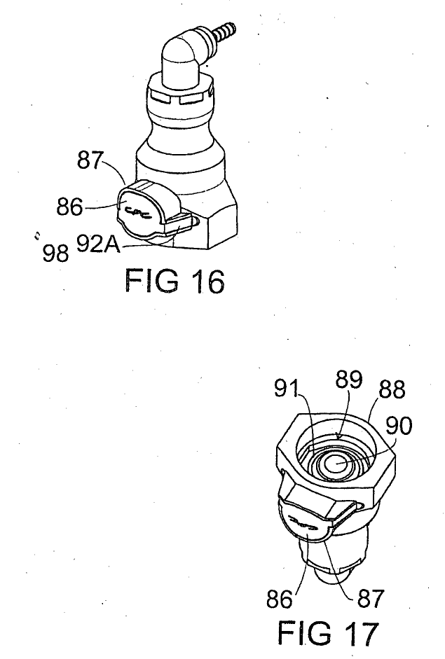

FIGS. 16-17 are alternative views of the plug component shown in FIG. 15;

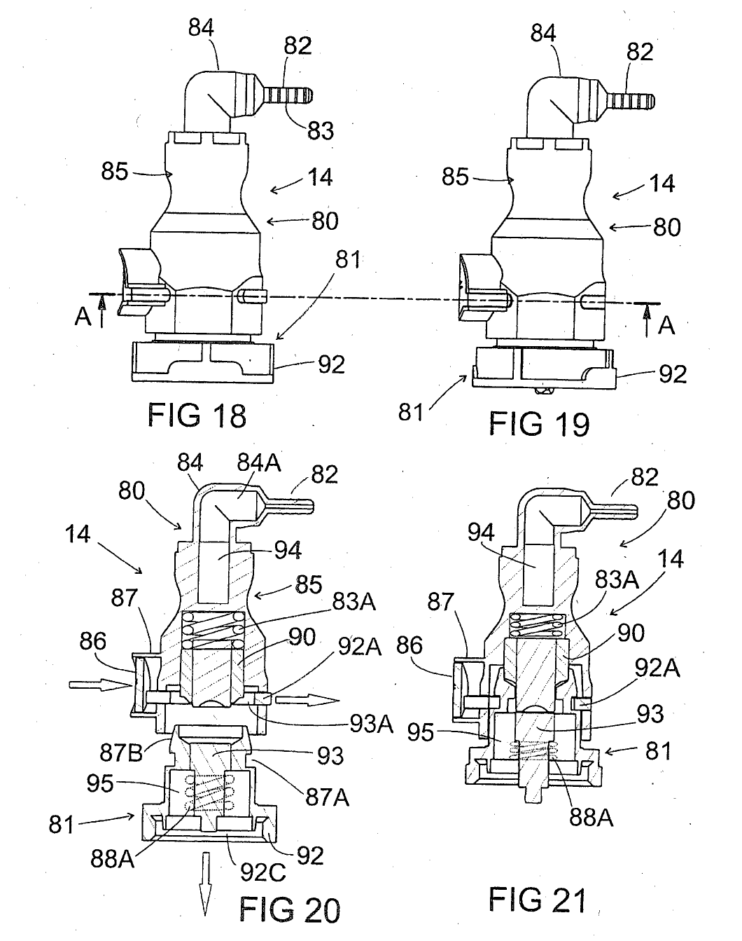

FIGS. 18-19 are alternative views of the fluid coupling shown in FIG. 15;

FIGS. 20-21 are longitudinal sectional views of the fluid coupling shown in FIGS. 18-19 in a separate state as well as an assembled state respectively;

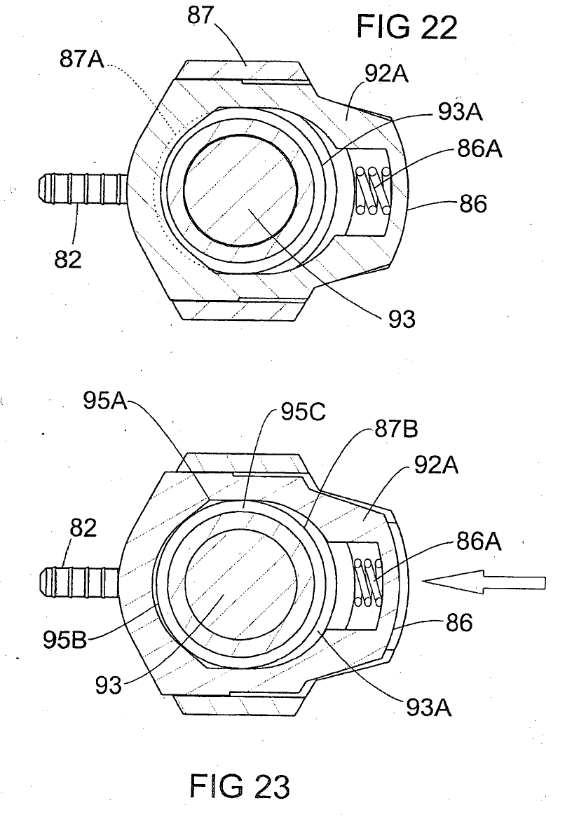

FIGS. 22-23 are sectional views along line A-A of FIGS. 18-19 showing the fluid coupling in the separate and assembled positions respectively;

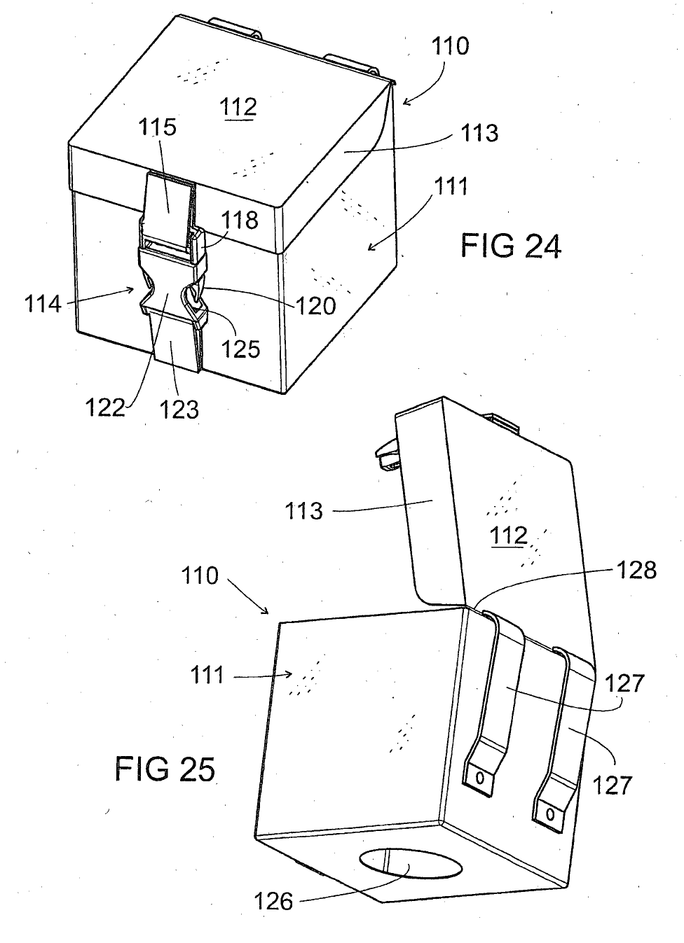

FIG. 24 is a perspective view of a pouch for use in retaining the combination of the bladder shown in FIG. 15 and the rigid housing also shown in FIG. 15;

FIG. 25 is a perspective view of the pouch of FIG. 24 when in an open position;

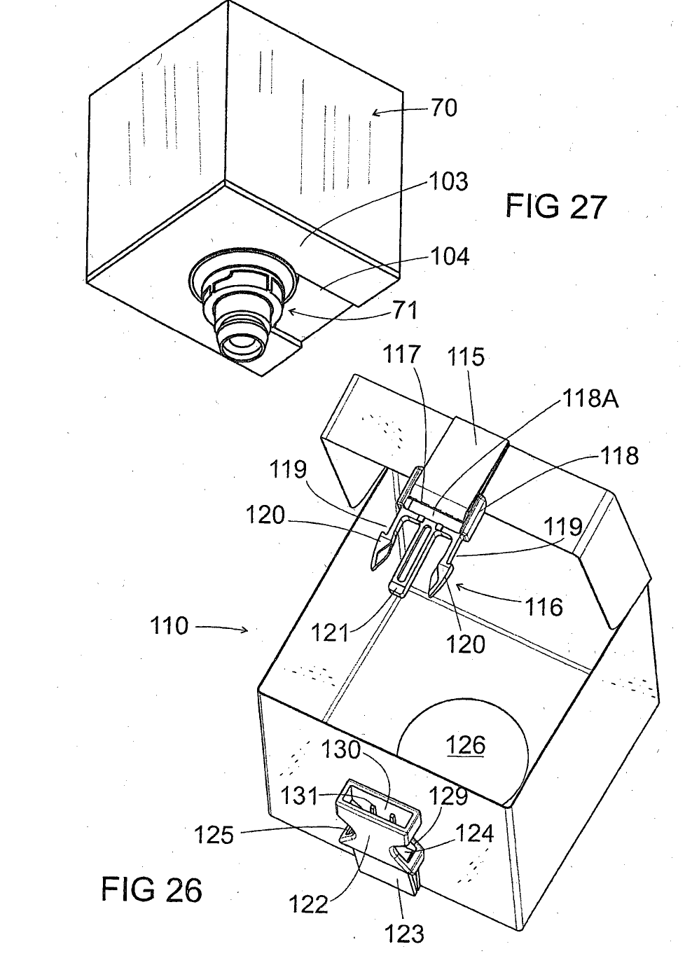

FIG. 26 is a perspective view of the pouch as shown in FIGS. 24-25 when shown in the open position ready to receive the rigid housing and bladder shown in FIG. 27;

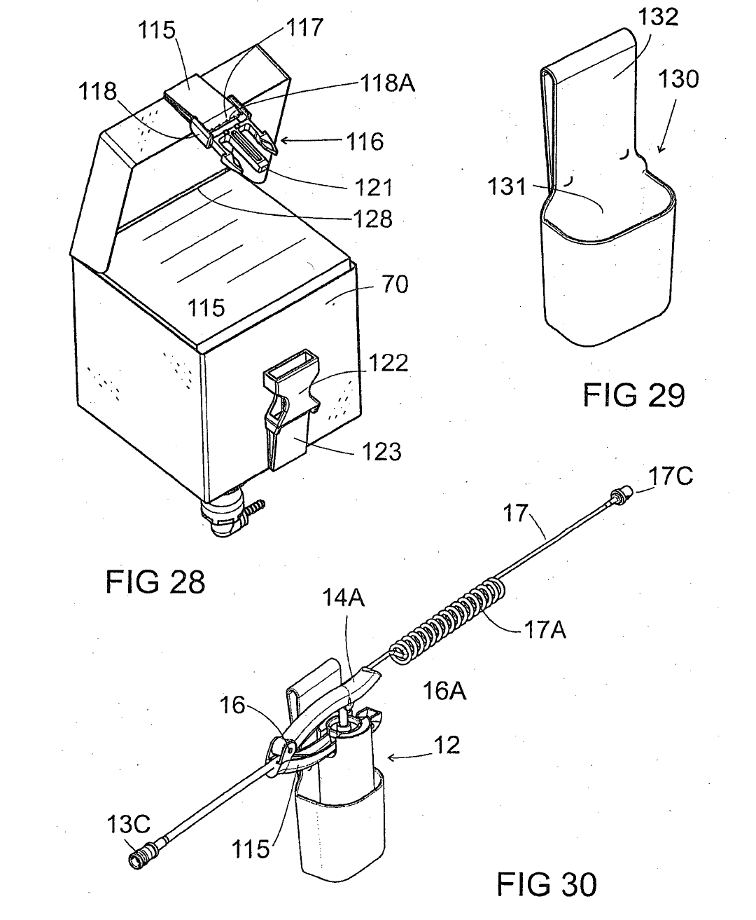

FIG. 28 is a perspective view of the pouch containing the rigid housing;

FIG. 29 is a perspective view of a holster for containing a pump;

FIG. 30 is a view of the holster shown in FIG. 29 containing a pump as previously shown in FIG. 10; and

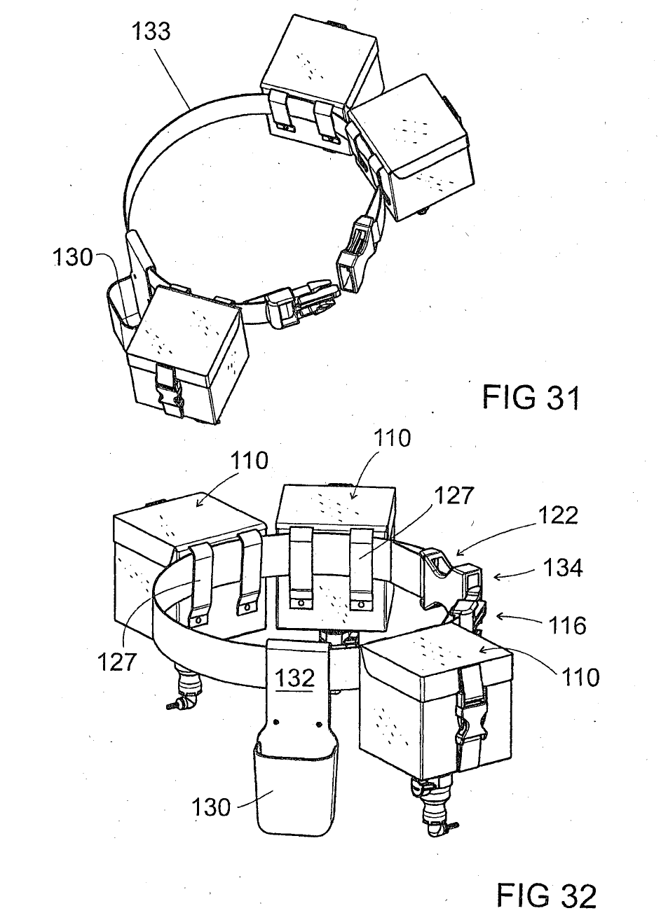

FIGS. 31-32 are alternative perspective views of a belt for use in the invention containing a plurality of pouches and a holster shown in FIG. 29.

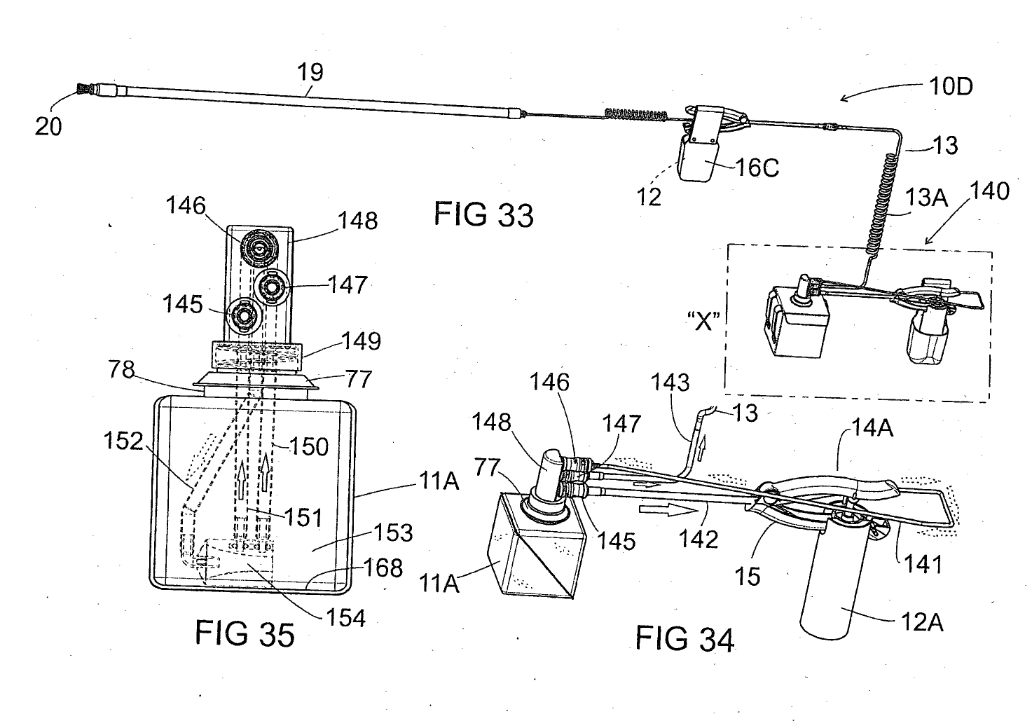

FIG. 33 refers to a different embodiment of the invention wherein use is made of a plurality of conduits interconnecting the bladder and pump;

FIG. 34 is a detailed view of feature “X” of FIG. 33;

FIG. 35 is a side view of a modified collapsible bladder for use in the embodiment of FIG. 33;

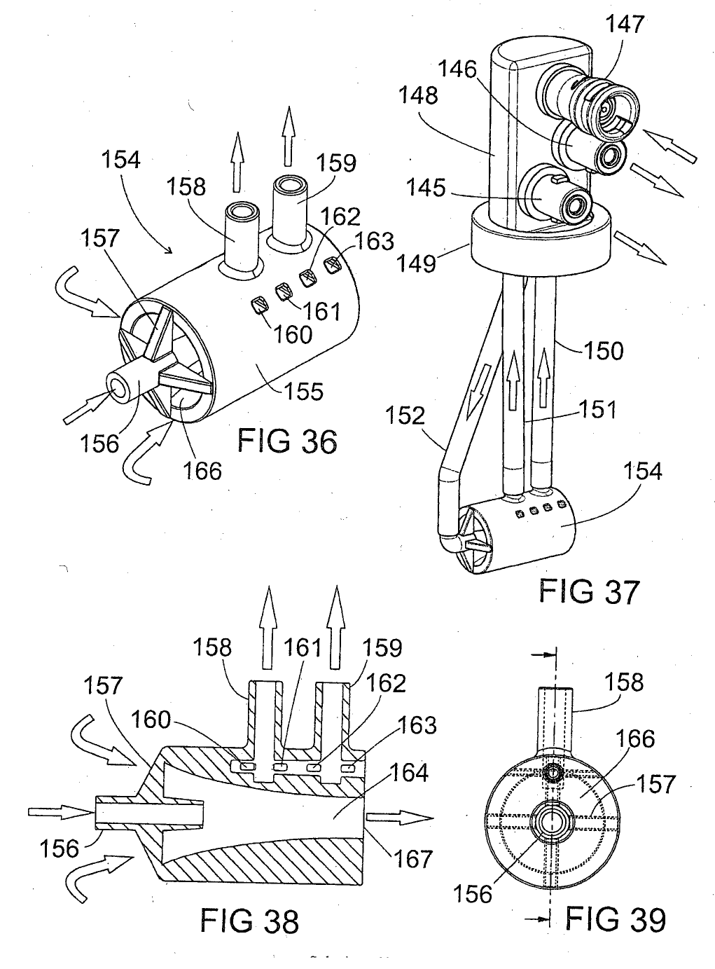

FIGS. 36-39 refer to a liquid pick up device in the form of a venturi for use with the embodiment of FIG. 33;

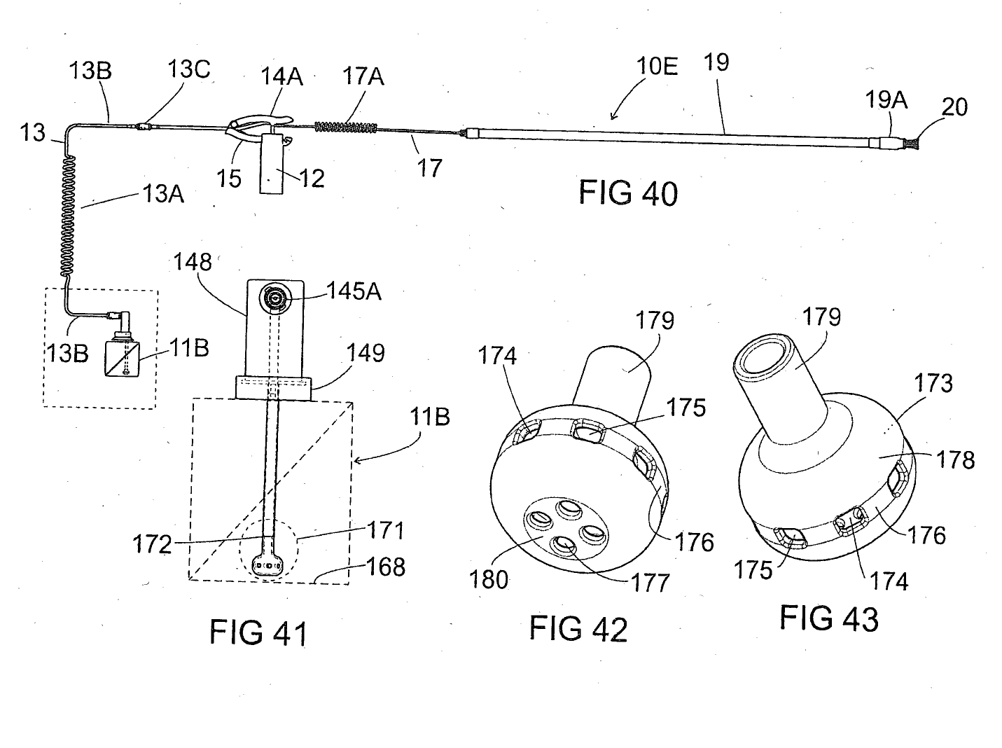

FIGS. 40-43 refer to a different embodiment of the invention to that shown in FIG. 33-39 wherein use is made of a different liquid pick up device;

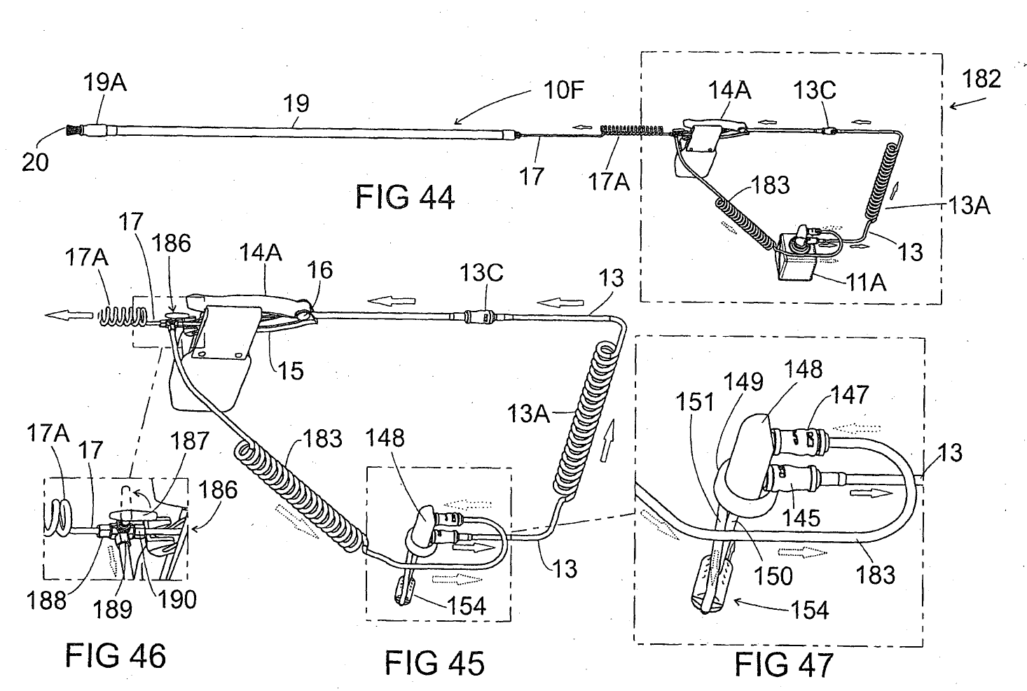

FIGS. 44-47 refer to a different embodiment of fluid applicator of the invention;

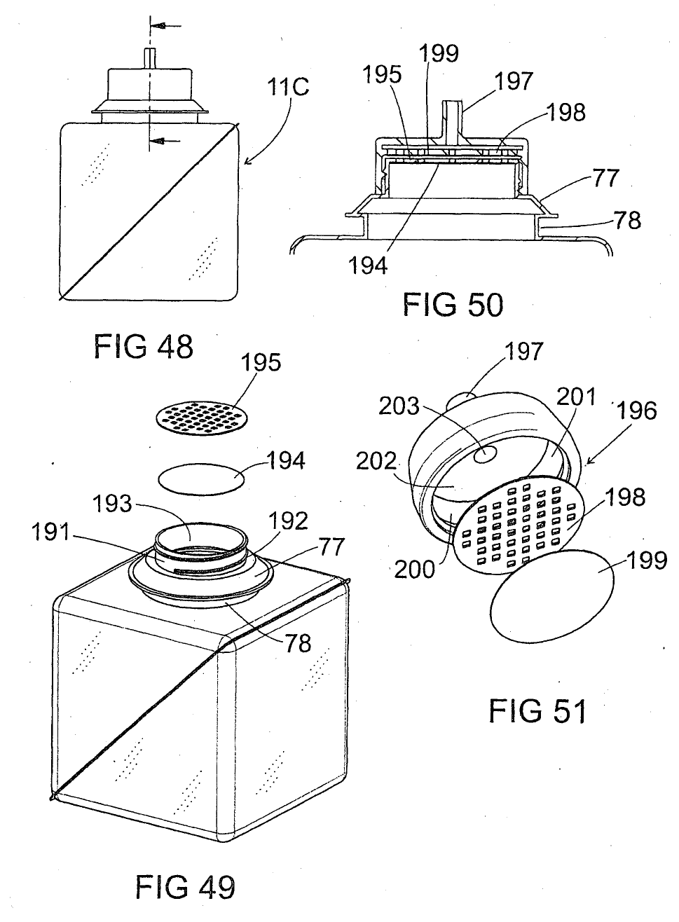

FIGS. 48-51 refer to a different embodiment of the invention using a hydrophobic membrane and mesh screen;

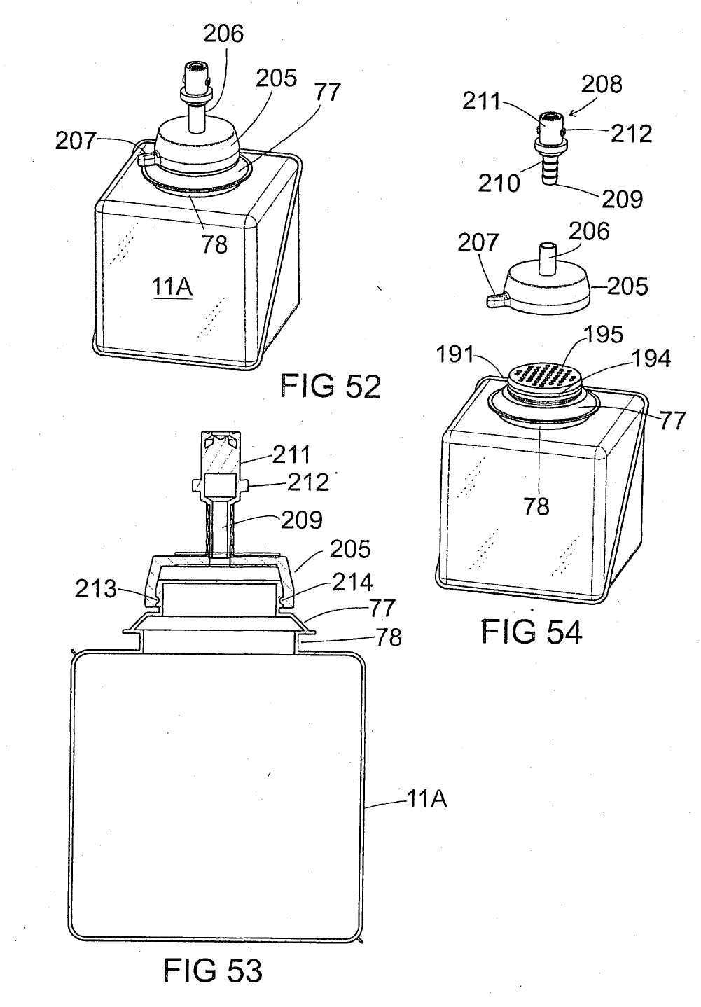

FIGS. 52-54 refer to a different embodiment of the invention to that shown in FIGS. 48-51;

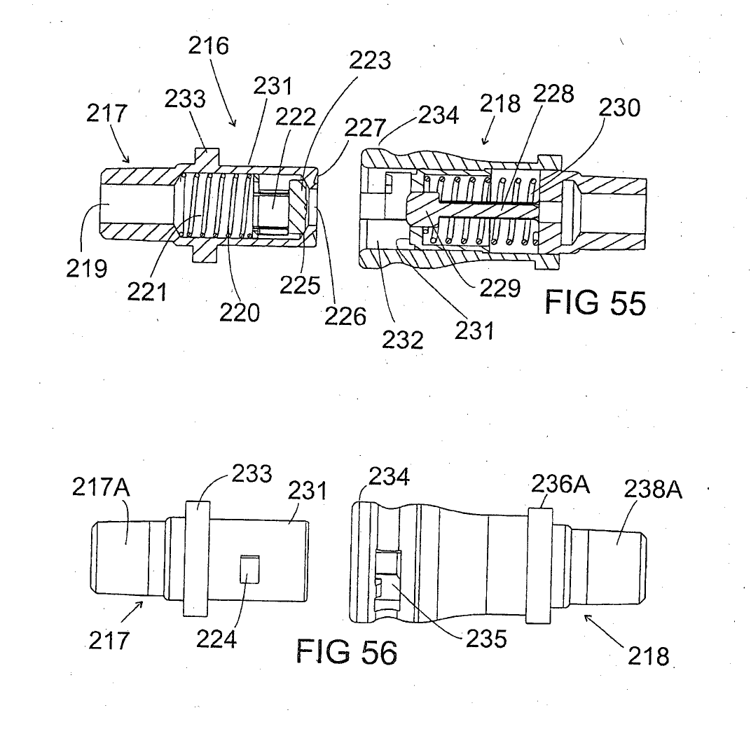

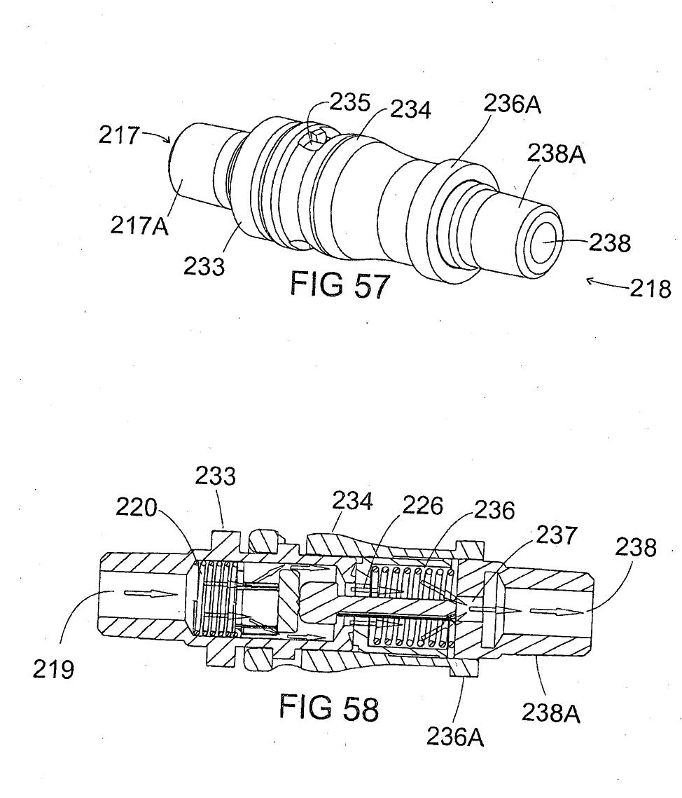

FIGS. 55-58 refer to use of a releasable connector for use with the embodiment of FIGS. 33, 40 and 44; and

FIGS. 58-60 refer to a different embodiment to that shown in FIG. 52-54.

In FIG. 1 there is shown applicator 10 having a collapsible bladder 11 connected to a positive displacement pump 12 by means of conduit or tube 13. Conduit 13 includes flexible section 13A, pipe section 13B and releasable connector 130. Conduit 13 is in fluid communication with fluid coupling 14 of bladder 11 as shown in FIG. 1A. In similar manner conduit 13 is in fluid communication with conduit 16A at 16B. Pump 12 has a trigger device 14A which is moved in a pumping action relative to a fixed handle 15.

In FIG. 1B there is shown releasable connector 13C having female socket 9A, male component 9B and a bayonet connection comprising apertures 9C and mating projection 9D. Releasable connector 13C is more fully explained in the embodiments of FIGS. 55-58.

In FIG. 10 there is shown movable trigger 14A which is pivoted to handle 15 at 16. Conduit 16A is attached to trigger 14A at 16B. There is also shown holster 16C for positive displacement pump 12 and suspension hook 16D. Conduit 16A is attached to a hollow piston 16E which has a one way valve and also includes check valves 16F and 16G for ensuring one way passage through conduit 16A. The lower end of pump 12 is connected to hose 17 having flexible section 17A.

FIG. 1D shows inlet 8 of rigid tube 19 connected to hose 17 wherein socket 17B engages with male part 17C. Tube 19 may be extendable having telescopic sections 18A and 18B. Tube 19 also has boot 19A which is flexible and releasably attached to holder 19B. Boot 19A also has a brush 20.

By virtue of the pumping action of trigger 14A, it will be appreciated that on each stroke of trigger device 14A, a constant or metered amount of fluid from collapsible bladder 11 passes through internal conduit 16A in pump 12 and into hose 17 connecting pump 12 and rigid tube 19. Again hose 17 may be connected to an outlet 9 of pump 12 and an inlet 8 of tube 19 by any suitable plug-socket engagement.

It will be appreciated that the metered amount can be varied within pump 12 by adjustment of an adjustment screw 7 attached to the piston 16E in pump 12.

In FIG. 2 there is shown an enlarged view of detail E shown in FIG. 1 which shows rigid tube 19 and brush 20. Brush 20 is supported solely by holder 19B which is releasably attached to internal conduit 21 of tube 19 at 22. Holder 19B has an internal passage 23 and brush 20 has a ferrule 24 which releasably engages with holder 19B by screw thread engagement, bayonet connection, interference fit or other plug-socket form of engagement. Ferrule 24 has a closed end 26 thus forcing liquid flow from passage 23 of holder 19B and then through transverse passage 27 as shown by the arrow to flow through outer galleries 28 of holder 19B to an internal compartment 29 which is formed between ferrule 24 and associated brush 20 and an outer housing or boot 19A formed of flexible material such as rubber or elastomeric material. Fluid in the form of a metered or calculated dose moves into compartment 29 which has a larger capacity than the metered or calculated dose so that different dosages may be utilised. The purpose of boot 19A is to form a seal for compartment 29 to prevent escape of fluid from compartment 29 and also to direct flow of fluid onto brush 20.

Thus in use fluid is drained out of compartment 29 onto brush 20 which may be applied to suitable vegetation such as weeds, noxious plants and the like. The advantage of including compartment 29 is that it functions as a buffer zone between activation of trigger device 14A and the amount or quantity of fluid drained from brush 20 onto a suitable plant (not shown).

In FIG. 3 there is also shown grooves 30 on holder 19B onto which the boot 19A seals. The boot 19A has internal ribs 31 that mate with grooves 30. There is also shown connector 32 used for releasable connection 22 which screw threadedly attaches to external conduit 21 at 33 and has hollow plug 34 for communicating with internal passage 23. Boot 19A also has a hollow end portion 35 for engagement with brush 20 to create internal compartment 29. Hollow end portion 35 also has end flange 36.

FIG. 4 also shows conduit looped or coiled part 37 of conduit 21. This is necessary to allow for tube 19 to be formed from telescopic components as described above.

In FIGS. 5-7 there is shown applicator 10A having bladder 11 with fluid coupling 14 which has fluid contained therein connected by hose 13B to trigger assembly 6 which has movable trigger 14A movable relative to handle 15 as described in FIG. 1C. The pump 12 also includes barrel or cylinder 15A, hollow passage 15B, engagement nut 150 connecting cylinder 15A to handle 15 and outlet 15D. The piston 16E is shown in FIG. 6. There is also shown brush 20 which is connected to holder 19A in a similar manner as shown in FIG. 2. It will also be appreciated that a metered amount of fluid, upon activation of trigger 14A, moves into compartment 29 shown in FIGS. 2-3 when required in a similar manner as described for the FIG. 1 embodiment.

The applicator 10B of FIGS. 8, 9, 10 and 11 functions in the same manner as described above in the FIG. 1 embodiment in relation to bladder 11, hose 13 and pump 12. However pump 12 is in flow connection with a hand piece 40 which has an operating trigger 41. Trigger 41 is pivotally mounted at 42 to support member 43 which is used for connecting to conduit 17 as well as supporting trigger 41.

Support member 43 is integrally connected to rigid tube 19 at 44. There is also shown at a free end 45 of tube 19, a pair of jaws or pincers 46 which are each pivotally attached to an end part 49 of tube 19 at 48.

The mechanism for movement of jaws 46 is shown in FIG. 11 wherein operating trigger 40 is operatively, connected to cable 51 at 52. End part 49 also includes triangular mount 53 for jaws 46. There is also shown return spring 54 mounted on spring retainer 55.

The fluid in delivery tube 21 is delivered to pads 46A by internal tubes (not shown) which travel through pivots 48 through jaws 46 and finally through pivots 47 to pads 46A.

This embodiment is designed for the purpose to transfer fluid onto pads 46A suitably made from foam, sponge material or felt material or indeed any material that can retain fluid and transfer fluid as may be required. Suitable targets are tall plants that can be held between pads 46A by jaws 46 for application of fluid to hirsute or hairy plants for which application by a brush would be ineffective. A clump of tall grasses is another form of suitable target vegetation.

The applicator 10C shown in FIG. 12-13 functions in a similar manner as shown in FIG. 1 with the exception that the elongate tube 19 terminates in a single pad 60 of the same material as described above for pads 46A. Pad 60 has a connection tube 62 which can be connected to holder 19B by any of the releasable attachment means described above. Flexible hose 21 is in fluid communication with hose 17 as well as pad 60. The purpose of this arrangement is to provide a similar function as brush 20.

In FIG. 14 is shown bladder 11 without fluid coupling 14 and in FIG. 15 there is shown an exploded perspective view of bladder 11 contained in box or carton 70 with fluid coupling 14 aligned with fluid access assembly 71 of bladder 11. Bladder 11 includes weld line or join 72 interconnecting components 73 and 74 and fluid access assembly 71 includes opening 75, screw thread portion 76 and outwardly extending flange 77. Spigot 78 engages with an opening (not shown) in top wall 79 of bladder 11 in permanent or welded relationship.

Fluid coupling 14 as shown in FIGS. 15-17 includes socket component 80 and plug component 81. Socket component 80 includes access conduit 82 having hose barbs 83, L shaped pipe or elbow 84 having internal passage 84A best shown in FIG. 20 and body 85. There is also provided spring loaded plunger 90, which has internal passage 82B best shown in FIG. 20 surrounded by flange 88 as well as O-ring 91. Socket component 80 is also provided with internal conduit 94. Plug component 81 also has spring operated plunger 93 having internal bore 93B best shown in FIG. 20, surround flange 87B, outer groove 87A and internal passage 95. Plug component 81 also has base part 92 which has an internal screw thread 92C best shown in FIG. 20 for engagement with screw threaded part 76 of access assembly 71. Push button 86 also has associated latch 92A.

As shown in FIGS. 18-23 plunger 90 is biased by spring 83A to the closed position shown in FIG. 21 and plunger 93 is biased by spring 88A also to the closed position shown in FIG. 21. Upon engagement of plug component 81 with socket component 80 as shown in FIGS. 20-21 both springs 83A and 88A are compressed with latch 92A having opening 93A which engages with groove 87A as shown in FIGS. 20-21.

In FIGS. 22-23 the action of push button 86 is shown in the closed position in FIG. 22 and in the open position in FIG. 23 under the influence of spring 86A which is biased towards the closed position shown in FIG. 22.

In FIG. 22 as shown in phantom opening 93A of latch part 92 engages with groove 87A and plunger 90 engages with plunger 93 as shown in FIG. 21. When push button 86 is moved, latch 92A disengages with groove 87A and opening 93A as shown in FIG. 23 and latch 92A is moved laterally as shown by the arrow in full outline to facilitate removal of pug component 81 from socket component 80 as shown in FIG. 20. In this regard opening 93A is provided with a shoulder 95A forming a smaller diameter part 95B and greater diameter part 95C. It is part 95B which engages with groove 87A in the closed position shown in FIG. 23.

In FIG. 15 there is also shown closure plug 135 having handle 135A to cover flange 87B of pug 81 to prevent leakage of fluid when required.

The box or container 70 as shown in FIG. 15 includes hollow interior 96 to retain bladder 11, cover 97 having opening 98 to enclose access assembly 71 and closure panel 99 which extends into space 100 and which is retained therein by tab 101 joined to box 70 by web 102A which engages into slot 102. There is also provided retaining plate 103 having notch 104 which engages with access assembly 71 to retain access assembly 71 in a position partially withdrawn from box 70 and bladder 11 when required.

In FIGS. 24-26 there is shown pouch 110 having body 111 and cover 112 with side flaps 113. There is also provided a closure mechanism 114 having strap 115, male component 116 shown in FIG. 26 connected to strap 115 by strap loop 117 engaging with retainer 118 having slot 118A and male members 119 having engagement tabs 120 and intermediate member 121 also as best shown in FIG. 26. Male component 116 engages with socket component 122 as shown in FIG. 24 which is retained in desired position by strap 123 having retaining loop 124 which engages with slot 125 of socket 122. The pouch 110 also has opening 126 and retaining straps 127 to engage with belt 133 as hereinafter described. Cover 112 is hinged to body 111 at 128.

In FIG. 24 it will be noted that engagement tabs 120 extend through socket 122 and are retained in spaces 129 with intermediate member 121 retained in slot 130 between ribs 131.

In FIG. 27 there is shown an inverted view of box or carton 70 containing bladder 11 which is retained in a desired orientation relative to pouch 110 whereby outwardly extending access assembly 71 extends through opening 126 when box 70 is inserted within hollow interior 127 of pouch 110.

In FIG. 29 there is shown a holster 130A having a hollow interior 131 and having support loop 132 attachable to a belt 133 as shown in FIG. 32

In FIG. 30 there is shown pump 12 located in hollow interior 131 of holster 130 in a similar manner as already described above in FIG. 1C.

In FIGS. 31-32 there are shown alternative perspective views of belt 133 which includes holster 130 attached thereto by support loop 132, a plurality of pouches 110 attached to belt 133 by retaining straps 127 and buckle 134 of belt 133 which functions in a similar manner to closure mechanism 114 already described above.

In FIGS. 33, 34 and 35 there is shown another embodiment of the invention wherein applicator 10D has been modified wherein collapsible bladder 11 and fluid coupling 14 have been omitted and replaced with an assembly 140 which includes a collapsible bladder 11A connected to an additional pump 12A. Bladder 11A is connected to pump 12A by conduits 141 and 142 and there is also provided conduit 143 which is connected to conduit 13.

Conduit 141 is connected to pump 12A in a similar manner as hose 17 shown in FIG. 10 and is also connected to releasable connector 146 associated with collapsible bladder 11A. Conduit 142 is connected to pump 12A in a similar manner as conduit 13B shown in FIG. 1C and also connected to releasable connector 145 associated with bladder 11A. Pump 12A also has movable trigger device 14A and fixed handle 15. Conduit 143 is connected to releasable connector 147 associated with bladder 11A.

Conduit 142 is a suction conduit delivering fluid from bladder 11A to pump 12A and conduit 141 transfers fluid from pump 12A to collapsible bladder 11A. Collapsible bladder 11A also has post 148 supporting releasable connectors 145, 146 and 147. There is also shown locking ring 149 which engages screw threaded part 192 shown in FIG. 49. There is also shown spigot 78.

There are also shown internal conduits 150, 151 and 152 which located in hollow interior 153 of bladder 11A. Conduit 150 interconnects releasable connector 147 and venturi device 154. Conduit 151 interconnects releasable connector 148 and venturi device 154 and conduit 152 interconnects releasable connector 146 and venturi device 154.

In FIGS. 36, 37, 38 and 39 there is shown detailed views of venturi device 154 and its association with conduits 150, 151 and 152.

In FIG. 36 venturi device 154 has a cylindrical body 155 and inlet 156 supported by reinforcement flanges 157 which is coupled to conduit 152. There are also provided outlets 158 and 159 which are in flow communication with apertures 160, 161, 162 and 163 which in turn couple to conduits 150 and 151 as shown in FIGS. 35 and 37.

FIG. 38 shows a hollow interior or venturi 164 of venturi device 154. Venturi device also includes openings 166 which are separated by reinforcement flanges 157. The pressure differential between venturi 164 and hollow interior 153 shown in FIG. 35 is totally caused by pressurized fluid being pumped through inlet or nozzle 156. This in turn causes additional fluid to be drawn into venturi 164 through openings 166. The combined volume of pressurized fluid pumped through inlet or nozzle 156 and fluid drawn into venturi 164 from openings 166 flows subsequently through exit 167 into hollow interior 153. This venturi action is totally independent of fluid flow through outlets 158 and 159 which is drawn through outlets 158 and 159 by the combined effect of pumps 12 and 12A.

The location of venturi device 154 on or closely adjacent to the bottom surface 168 of bladder 12A controls deformation of bladder 11A to ensure that fluid pick up through venturi device 154 is always occurring within the region of bottom surface 168 shown in FIG. 35.

In FIGS. 40-43 there is shown applicator 10E having modified bladder 11B wherein conduit 13B is attached to a single releasable connector 145A which communicates with internal conduit 170 which is attached to fluid pick up device 171 at 172. Fluid pick up device 171 has a hollow interior 173 and a plurality of side inlets 174 each having a surrounding recess 175 and which are located in a continuous recess 176. There are also provided bottom inlets 177 located in a cavity 180. Pick up device 171 also has body 178 and hollow attachment tube 179 for attachment to conduit 170. The purpose of surrounding recess 175 and/or continuous recess 176 as well as cavity 180 is to prevent inlets 174 and 177 being closed or shut off by deformation of bladder 11B.

In FIGS. 44-47 there is shown another embodiment of the invention showing applicator 10F having an assembly 182 of pump 12A with bladder 11A wherein fluid is transferred from bladder 11A to pump 12A and may be diverted through conduit 183 back to bladder 11A or delivered to applicator 20 through conduit 17.

FIGS. 45 and 47 show conduit 13 being attached to releasable connector 145 and conduit 183 being attached to releasable connector 147. There is also shown venturi device 154 and associated conduits 150 and 151.

In FIG. 46 there is provided a diverter valve 186 which may be a conventional 3 way valve having a handle 187 and separate passageways 188, 189 and 190 whereby fluid may be diverted through conduit 17 and conduit 17A as shown by the arrow or through conduit 183. Fluid is also fed to valve 186 through conduits 13 and 13A.

FIGS. 48-51 refer to another embodiment of the invention wherein bladder 11C is designed to be disposable. The bladder 11C as shown in FIG. 49 has a neck 191 which has a screw thread 192 and internal surface 193. There is also provided a hydrophobic membrane 194 and optionally a mesh screen 195 which are welded or permanently fixed to neck 191. There is also provided a cap 196 shown in FIG. 51 which has a spigot 197 for connection to conduit 13. It is important to note that in this embodiment hydraulic coupling 14 is omitted or not required. Cap 196 has a mesh screen 198 and hydrophobic membrane 199 which are permanently retained within interior 200 of cap 196 for example by welding to side wall 201 and top wall 202. Top wall 202 has flow aperture 203. FIG. 50 is a sectional view of FIG. 48 as shown and shows an assembled view of cap 196 being attached to neck 191.

This embodiment utilises hydrophobic membranes in place of valved releasable fluid couplings. Liquid flow across these membranes is caused by taking advantage of the concept of Water Breatkthrough Pressure.

When pump 12 is activated a vacuum is created on the pump side of the membranes. This in turn creates a pressure differential between atmospheric pressure acting on the contents of the collapsible bladder 11A and the suction side of pump 12. When this pressure differential reaches a pre-determined “Breakthrough” pressure it allows liquid to “leak” or flow across the membranes 194 and 199.

If there is no pressure differential the two membranes 194 and 199 can be separated with no further leakage of liquid.

FIGS. 52, 53 and 54 also refer to a similar arrangement as shown in FIGS. 48-51. However there is provided a modified cap 205 which has a top spigot 206 and finger grip 207. There is also provided a barbed fitting 208 which has a depending part 209 having barbs 210 for attachment to top spigot 206. Fitting 208 also has a releasable component 211 having bayonet lugs 212 for attachment to a female coupling (not shown in FIGS. 52, 53 and 54). This female coupling is connected to conduit 13. Cap 205 is shown as a snap fit cap but a screw thread may also be used. Cap 205 also has lip 213 which attached to groove 214 of bladder 11A as shown in FIG. 53.

FIGS. 55-58 show a releasable coupling 216 for use in the invention similar to releasable fitting 13C previously described. It has a male component 217 similar to male coupling 211 described above and a female component 218. Male component 217 has end passage 219 of smaller diameter than internal passage 220 which retains spring 221 and movable plunger 222 having a head 223. Male component 217 also has bayonet lugs 224. There is also provided an abutment 225 which retains head 223 in desired location within internal passage 220 biased by spring 221. Abutment 225 surrounds end aperture 226. Male component 217 also has end abutment faces 227.

Female component 218 has a fixed plunger 228 having head 229 which is surrounded by spring 230. There is also provided internal abutments 231 which contact end abutment faces 227 when male component 217 is inserted into female component 218 as shown in FIG. 58. Female component 218 also has end space 232 which receives lug part 231 of male component 217 as shown in FIG. 58. Male component 217 also has flange 233 which is located adjacent to end rib 234 of female component 218 as shown in FIG. 58.

Upon insertion of male component 217 into female component 218 as shown in FIG. 58 bayonet lugs 224 engage in corresponding slots 235 to complete engagement of male component 217 with female component 218. When this occurs heads 223 and 229 engage causing compression of springs 221 and 229A which locks male component 217 within female component 218 allowing fluid flow through coupling 216 as shown by the arrows in bold through end passage 219, internal passage 220 around heads 223 and 229, through end passage 226 and into internal passage 236 of female component 218 and attachment flow passage 237 and 238.

Female component 218 also includes end section 238A, rib 236A and male component 217 also has end part 217A.

Instead of using mating bayonet parts 224 and 235 it will also be appreciated that such bayonet parts may also be replaced by mating screw threads if required.

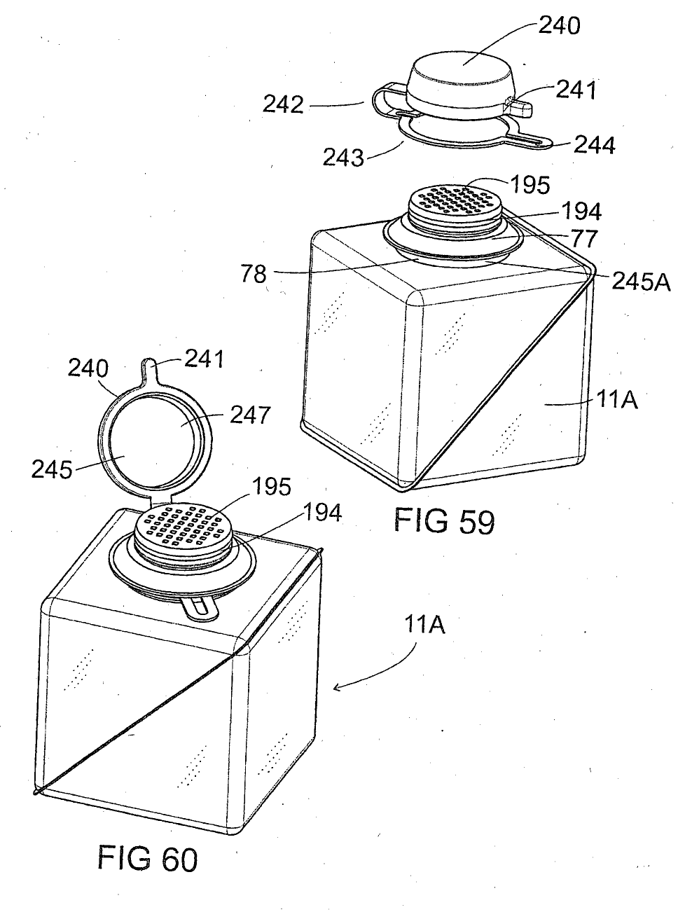

to FIGS. 59-60 show a final embodiment of the invention wherein fluid retention cap 240 is provided with hydrophobic membrane 194 and optionally a mesh screen 195 as shown in FIG. 49 and FIG. 50. Cap 240 has fingergrip 241 and web 242 interconnecting cap 240 with a bottom loop 243 also having fingergrip 244. Bottom loop 243 locates in groove 245A under flange 77 and spigot 78. Cap 240 also has hollow interior 245 into which hydrophobic membrane 194 and mesh screen 19 may fit with mesh screen 195 abutting adjacent surface 247 of cap 240.

It also will be appreciated from the above that cap 196 may also be provided with barbed fitting 208.

The advantages of the use of a collapsible bladder in combination with the hydraulic coupling means that in use the bladder collapses progressively as liquid is pumped or withdrawn from the bladder. This means that the container can therefore be collapsed to a state whereby it cannot contain any fluid or only a minimal amount of fluid so that a maximum amount of fluid may be withdrawn from the bladder. The collapsed state of the bladder facilitates either its disposal or return to be replenished when appropriate. This creates an extremely user friendly situation.

It also will be appreciated that a plurality of collapsible bladders may be carried on belt 133 so that after one bladder is empty it can be replaced by a full container. The provision of the fluid coupling having both male and female components which are releasably attachable to each other means that a number of different fluids or liquids may be readily accessed by the user. Thus for example, different herbicides which are active against different plants can be selected in the same expedition. It will also be appreciated that one of the bladders may contain water which can wash or clean out contact devices when required.

The advantages of use of a collapsible bladder for use in the preferred embodiments of the invention has the following advantages, i.e:
(i) The collapsed bladder can and should be refilled in a professional or commercial facility. This of course does not apply to the disposable option;
(ii) The use of a collapsible bladder reduces/removes risk of potentially dangerous liquids leaking from faulty ventilation valves in rigid containers;
(iii) The use of a “dry-break” or “double shut-off” hydraulic coupling minimizes the risk of operator exposure to potentially dangerous substances when coupling or decoupling;
(iv) The use of an interchangeable container removes the risk of spillage of and/or operator exposure to potentially dangerous liquids during (traditional) “on-site” refilling activities;
(v) The provision of pre-mixed products eliminates/removes the risk of operator calibration error when mixing (diluting) chemical concentrates;
(vi) The provision of pre-mixed products eliminates/removes the risk associated with the use of water of uncertain quality to dilute chemical concentrates; and
(vii) The benefits of personnel carrying a fraction of the weight of traditional equipment such as hydraulic knapsack sprayers.

Another advantage of the applicator of the invention is that it is user friendly and environmentally friendly.

Also the use of the venturi device 154 is advantageous because it provides a mechanism to agitate liquid in bladder 11 and 11A. This allows for products such as suspension concentrates or liquid combinations which tend to separate if not kept in a state of agitation.

1. A liquid applicator having:
(i) a container in the form of a collapsible bladder for containing a supply of liquid in use;
(ii) one or more positive displacement pumps in flow communication with the container which has a variable capacity chamber for delivering a metered or measured dosage of liquid; and
(iii) a contact device in flow communication with the positive displacement pump wherein said metered or measured dosage of liquid is delivered to a plant or other substrate.

2. A liquid applicator as claimed in claim 1 wherein the collapsible bladder is housed in a rigid box or other support structure to enhance stability of the collapsible bladder in use.

3. A liquid applicator as claimed in claim 1 wherein the collapsible bladder is provided with a fluid coupling which is releasably attached to a conduit in flow communication with the pump and contact device.

4. A liquid applicator as claimed in claim 2 wherein the collapsible bladder is provided with a fluid coupling which is releasably attached to a conduit in flow communication with the pump and contact wherein the fluid coupling extends outwardly from the rigid box or support structure and which fluid coupling is releasably attached to an inlet of the rigid box or support structure.

5. A liquid applicator as claimed in claim 3 or 4 wherein the fluid coupling has a plug component and a socket component which when connected to each other provide for liquid to enter the collapsible bladder from the conduit.

6. A liquid applicator as claimed in claim 5 wherein the plug component and the socket component are each provided with a valve assembly which co-operate with each other to allow liquid access to the collapsible bladder.

7. A liquid applicator as claimed in claim 6 having an actuator for actuating movement of each valve assembly to allow disconnection of the plug component from the socket component.

8. A liquid applicator as claimed in claim 7 wherein the actuator is a movable actuator which when moved causes movement of a valve member in each valve assembly under the influence of an associated spring from a locked position facilitating assembly of the plug component and the socket component to an unlocked position allowing separation of the plug component and the socket component.

9. A liquid applicator as claimed in claim 8 wherein when the movable actuator is moved it releases a latch which normally retains the plug component within the female component in an assembled position but when moved causes separation of the plug component from the female component.

10. A liquid applicator as claimed in claim 4 wherein the rigid box is provided with an opening in a top or bottom wall to facilitate outward extension of the fluid coupling.

11. A liquid applicator as claimed in claim 10 wherein the rigid box has a retaining plate with a notch or aperture to retain the hydraulic coupling in an outwardly extending orientation.

12. A liquid applicator as claimed in claim 11 wherein there is provided a pouch having a movable cover to allow insertion of the rigid box within the pouch with an end wall of the pouch having an opening to facilitate outward extension of the hydraulic coupling.

13. A liquid applicator as claimed in claim 12 wherein there is provided a belt to be worn by a user to which may be releasably attached one or more pouches as well as one or more holsters each incorporating a pump.

14. A liquid applicator as claimed in claim 4 wherein the fluid coupling extends upwardly from said collapsible bladder.

15. A liquid applicator as claimed in claim 14 wherein the collapsible bladder is provided with an upstanding post or extension which has one or more releasable connectors for connection to one or more conduits in flow communication with the collapsible bladder and said positive displacement pump and an additional positive displacement pump.

16. A liquid applicator as claimed in claim 15 wherein a fluid pick up device is included in the collapsible bladder on or adjacent a bottom surface thereof in fluid communication with said one or more conduits.

17. A liquid applicator as claimed in claim 15 wherein the fluid pickup device incorporates a venturi to ensure that the liquid in the collapsible bladder remains in a state of agitation.

18. A liquid applicator as claimed in claim 15, 16 or 17 including an additional positive displacement pump which has a first conduit interconnecting the additional pump and a first releasable connector for passage of fluid to the additional first pump from the first releasable connector and a second conduit for passage of fluid from a second releasable connector to the contact device and a third conduit for passage of fluid from a third releasable connector to the additional pump.

19. A liquid applicator as claimed in claim 17 wherein there is provided a pair of releasable connectors and a first conduit connected to one releasable connector and a second conduit connected to the other releasable connector and there is further provided a diversion valve adjacent the positive displacement pump in fluid communication with said first and second conduits for diversion of fluid to travel towards the contact device or back towards the container.

20. A liquid applicator as claimed in any one of claims 1-2 wherein an inlet of the collapsible bladder is provided with a hydrophobic membrane and an optional mesh screen.

21. A liquid applicator as claimed in claim 20 wherein there is provided a cap which also incorporates a hydrophobic membrane and a mesh screen.
